(19) United States
(12) Patent Application Publication
(10) Pub. No.: US 2023/0216337 A1
(43) Pub. Date: Jul. 6, 2023

(54) STACKED POWER SUPPLY SYSTEM

(71) Applicant: ELITEGROUP COMPUTER SYSTEMS CO., LTD., Taipei (TW)

(72) Inventors: CHIEHWE KU, Taipei (TW); CHIALIN CHANG, Taipei (TW); YU-PING WENG, Taipei (TW)

(21) Appl. No.: 17/746,928

(22) Filed: May 17, 2022

(30) Foreign Application Priority Data
Jan. 6, 2022 (TW) 111100556

(51) Int. Cl. H02J 9/06; H01M 50/512; H02J 7/00; H01M 10/48

(52) U.S. Cl. CPC H02J 9/062; H01M 10/482; H01M 10/488; H01M 50/512; H02J 7/0045

(57) ABSTRACT

A stacked power supply system applied for an electronic device is provided. The stacked power supply system has an adapter and multiple battery modules. The adapter has a power plug, a power supply connector and a battery connector. The adapter is connected to an external AC power via the power plug, and converts the alternating current to the direct current, so as to supply power to the electronic device via the power supply connector. The battery modules have a battery set, a first connector and a second connector. The first connector of one of the battery modules is electrically connected to the battery connector of the adapter, the second connector of other neighboring battery modules is adapted to the first connectors of the neighboring battery modules, so as to form a stacked battery modules structure.

### CROSS-REFERENCE TO RELATED APPLICATION

This application claims the priority benefit of TW Application Serial No. 111100556, filed on Jan. 6, 2022, the full disclosure of which is incorporated herein by reference.

### BACKGROUND

### Technical Field

The present disclosure relates to a stacked power supply system. More particularly, the present disclosure relates to the power supply applied for an electronic device, so as to be an uninterruptible power system (UPS).

### Description of Related Art

Since the advent of the portable computer, it has become one of the most popular electronic devices for modern people to carry around. As the performance of the portable computer is gradually improved, the power consumption is also increased. In present technology, the portable computer not only contains an internal battery, but also can be connected to a power supply via an adapter simultaneously. Accordingly, even there is power on the internal battery, the portable computer can be powered by the power supply, and meanwhile the internal battery is charged.

However, owing to the need of lightweight for the portable computer, the battery capacity is usually not too large. On the other hand, there is not always an external AC power can be provided to the power supply when using the portable computer, so that the battery life becomes an important issue of the portable computer. Therefore, how to develop an uninterruptible power system (UPS) to solve the issue above is a big trend.

### SUMMARY

In order to solve the problem described above, the present disclosure provides a stacked power supply system applied to electronic devices, the stacked power supply system includes an adapter and multiple battery modules. The adapter has a power plug, a power supply connector and a battery connector. The adapter is connected to an external AC power supply via the power plug, and the alternating current is converted to the direct current by the adapter, so as to supply power to the electronic device via the power supply connector. The battery module has a battery set, a first connector and a second connector. The first connector of one of the battery modules is electrically connected to the battery connector of the adapter, the second connector of other neighboring battery modules is adapted to be connected to the first connectors of the neighboring battery modules, so as to form a stacked battery modules structure.

According to an embodiment of the present disclosure, the battery connector of the adapter is a male connector or a female connector.

According to an embodiment of the present disclosure, the battery pack has one or more batteries, the batteries are connected in parallel when there is more than one battery in the battery set.

According to an embodiment of the present disclosure, when the battery connector of the adapter is a male connector, the first connector of the battery modules is corresponded to a female connector, and the second connector of the battery modules is corresponded to a male connector.

According to an embodiment of the present disclosure, when the battery connector of the adapter is a female connector, the first connector of the battery modules is corresponded to a male connector, and the second connector of the battery modules is corresponded to a female connector.

According to an embodiment of the present disclosure, there is a case on the battery modules, wherein the case has the first side and the second side, the first side is parallel to the second side, the first side is the side facing to the battery connector of the adapter, the second side is opposite side being away from the battery connector of the adapter, and the first connector is disposed on the first side, the second connector is disposed on the second side.

According to an embodiment of the present disclosure, there is a contact surface on the adapter, and the battery connector is disposed on the contact surface.

According to an embodiment of the present disclosure, the contact surface of the adapter and the first side and the second side of the battery modules are closely fitted to the first connector and the second connector of the detachable battery modules via the battery connector of the adapter.

In summary, the stacked power supply system in the present disclosure uses multiple battery modules externally connected to the adapter, so that even the electronic device is disconnect to an external AC power, the electronic device can also form a UPS structure by utilizing the battery modules. Furthermore, users can elastically adjust the number of the battery modules by themselves according to their own needs, so as to improve the battery life of the electronic device and avoid the issue that there is not always an external AC power can be provided to the power supply when using the portable computer, so the electronic device may have to be interrupted due to the lack of power.

### BRIEF DESCRIPTION OF THE DRAWINGS

The accompanying drawings are provided to enable person having ordinary skill in the art can further understand the present disclosure, and the accompanying drawings are incorporated in and as a part of the specification of the present disclosure. The accompanying drawings illustrate exemplary embodiments of the present disclosure, and the description in the specification of the present disclosure is served to explain together the principal of the present disclosure.

FIG. 1 is the schematic diagram of essential elements of the stacked power supply system according to an embodiment of the present disclosure.

FIG. 2A is the schematic diagram of the stacked structure according to an embodiment of the present disclosure.

FIG. 2B is the schematic diagram of the stacked structure according to an embodiment of the present disclosure.

### DETAILED DESCRIPTION

Reference will now be made in detail to exemplary embodiments of the present disclosure, exemplary embodiments of which are illustrated in the accompanying drawings. Wherever possible, the same element number is used in the drawings and the description to refer to the same or the similar part. Furthermore, exemplary embodiments are only one of implemental ways in the concept of design of the present disclosure, none of exemplars described below is intended to limit the present disclosure.

Given that the issue of the prior art, the present disclosure provides a stacked power supply system applied for electronic devices. For instance, the stacked power supply system is preferably provided to a notebook as a power supply.

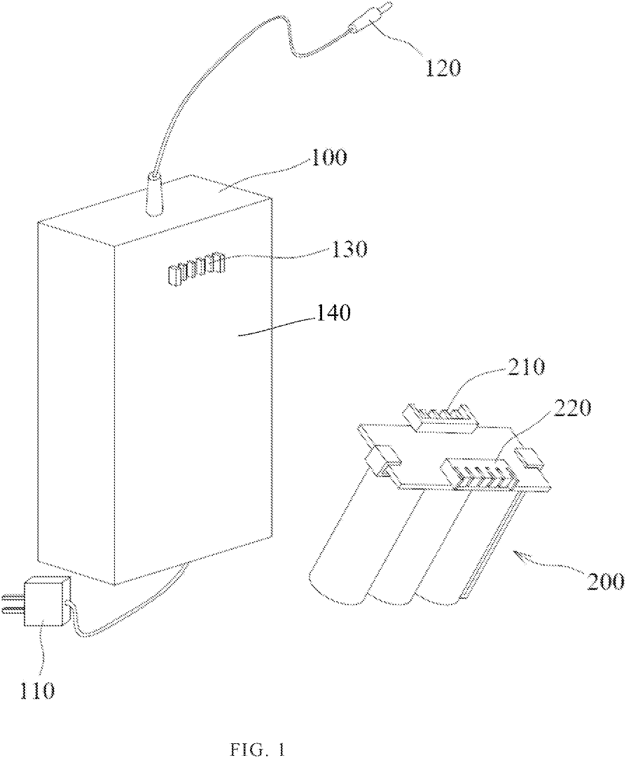

Refer to FIG. 1. FIG. 1 is the schematic diagram of essential elements of the stacked power supply system according to an embodiment of the present disclosure. The stacked power supply system includes an adapter 100 and multiple battery modules 200.

The adapter 100 has a power plug 110, a power supply connector 120 and a battery connector 130. The adapter 100 is adapted to be connected to the external AC power via the power plug 110 and convert the alternating current to the direct current, so as to supply power to the electronic device via connecting the power supply connector 120 to the electronic device.

The battery modules 200 are respectively include a battery set 230, a first connector 210 and a second connector 220. The first connector 210 of one of the battery modules 200 is electrically connected to the battery connector 130 of the adapter, and the second connector 220 of the other neighboring battery modules 200 is adapted to be connected to the first connector 210 of the neighboring battery modules 200, so as to form a stacked structure of the battery modules.

According to an embodiment of the present disclosure, the battery connector 130 of the adapter 100 is a male connector of a female connector, but the present disclosure is not limited thereto.

According to an embodiment of the present disclosure, there is more than one battery in the battery set 230 described above, and these batteries are connected in parallel.

According to an embodiment of the present disclosure, once the battery connector 130 of the adapter 110 is a male connector, the first connector 210 of the battery modules 200 is corresponded to a female connector, and the second connector 220 of the battery modules 200 is corresponded to a male connector, but the present disclosure is not limited thereto.

According to a preferably embodiment of the present disclosure, when the battery connector 130 of the adapter 100 is a female connector, the first connector 210 of the battery modules 200 is corresponded to a male connector, and the second connector 220 of the battery modules 200 is corresponded to a female connector, but the present disclosure is not limited thereto.

According to an embodiment of the present disclosure, there is a case on the battery modules 200, the case has a first side and a second side, the first side is parallel to the second side, the first side is the side facing to the battery connector 130 of the adapter 100, the second side is the other side being away from the battery connector 130 of the adapter 100, and the first connector 210 is disposed on the first side, the second connector 220 is disposed on the second side.

Additionally, there can further be a battery level indicator on the case, and the battery level indicator will remind once the battery capacity in the battery modules 200 is run out.

For example, the battery level indicator can be an indicator device with multiple flashing lights (e.g. multiple LED lights), and the battery level indicator is set to display different number of lights according to different power capacities, so that users can discriminate the battery capacity of the battery module 200 in use.

As described above, there can further be an audio alarm on battery level indicator, once the battery capacity in the battery module 200 in use is not enough to supply power, the audio alarm will alarm users to replace the battery module 200.

According to an embodiment of the present disclosure, there is a contact surface 140 on the adapter 100, and the batter connector 130 is disposed on the contact surface 140.

According to an embodiment of the present disclosure, the contact surface 140 of the adapter 100 and the first side and the second side of the battery modules 200 are closely fitted to the first connector 210 and the second connector 220 of the battery modules 200 via the battery connector 130 of the adapter 100, so as to form the stacked structure of the battery modules.

The overview of the power supply method of the stacked power supply system in the present disclosure is as follows:

Generally, without setting the battery modules 200, when the power plug 110 of the adapter 100 is connected to the external AC power, the adapter 100 will convert the external alternative current to the direct current and supply power to the electronic device via the power supply connector 120.

Then, with setting the battery module 200, once the battery capacity of the detachable battery 200 is not fully charged, and the power plug 110 of the adapter 100 is adapted to be connected to the external AC power, the adapter 100 will not only supply the direct current converted from the alternative current to the electronic device via the power supply connector 120, but also supply power to the battery modules 200 via the battery connector 130.

As mentioned above, once there are multiple battery modules 200 set to the adapter 100 are not fully charged, preferably, one of the battery modules 200 which is the nearest one to the adapter 100 will be charged firstly. After the battery modules 200 which is the nearest one to the adapter 100 is fully charged, another one of the battery modules 200 which is farther from the adapter 100 will be charged in sequence until all batteries are fully charged.

For instance, there are three battery modules 200 set to the adapter 100, wherein the three battery modules 200 are connected to form a stacked structure of the battery pack via the battery connector 130 of the adapter 100, the first connector 210 and the second connector 220 of the battery modules 200. Then, the battery capacities of the three battery modules 200 are respectively 80%, 70% and 50% according to the distance of the adapter 100 from near to far. The adapter 100 will firstly fully charge the detachable battery 200 which is the nearest one to the adapter 100 and the battery capacity is 80% via the battery connector 130. After, the adapter 100 will fully charge the battery module 200 which is the second nearest one to the adapter 100 (e.g. the one in the middle of the three battery modules 200) and the battery capacity is 70% via the battery connector 130. At last, the adapter 100 will fully charge the detachable battery 200 which is the farthest one to the adapter 100 and the battery capacity is 50% via the battery connector 130. As such above, the power consumption due to the distance during the power transmission can be minimized in use.

Nevertheless, the technical manner above is not limited thereto, for example, another power supply method to the battery modules 200 via the battery connector 130 of adapter 100 can charge multiple battery modules 200 simultaneously, so that these battery modules 200 can remain the same battery capacity and be fully charged gradually.

As an example, there are three battery modules 200 configured to the adapter 100 so as to form a stacked power supply system, wherein the battery capacities of the three battery modules 200 are respectively 50%, 90% and 70% according to the distance of the adapter 100 from near to far. The adapter 100 will firstly charge one of the detachable batteries 200 with the lowest battery capacity, i.e. the battery capacity is 50%, to 70% via the battery connector 130.

After, the adapter 100 will charge the two battery modules 200 with the battery capacity of 70% together to 90%. At last, the adapter 100 will fully charge the three battery modules 200 with the battery capacity of 90% together.

As such above, the battery life of the battery modules 200 will not decrease due to the passing of the continuous current when fully charged.

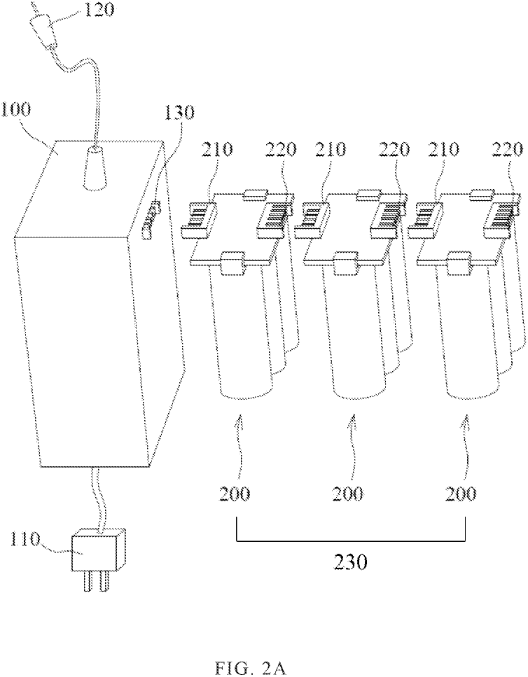

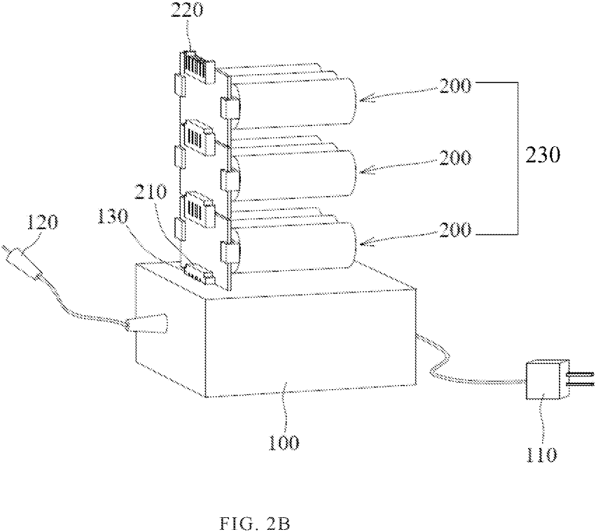

The detailed description of the stacked structure of the battery pack is referred to FIG. 2A and FIG. 2B. FIG. 2A is the schematic diagram of the stacked structure according to an embodiment of the present disclosure. FIG. 2B is the schematic diagram of the stacked structure according to an embodiment of the present disclosure. FIG. 2A shows that the arrangement pattern that the adapter 100 and multiple battery modules 200 are not connected together.

According to an embodiment in the present disclosure, due to not every time we will take battery modules 200 when using the adapter 100, it is better that the battery connector 130 is a female connector, so as to avoid the danger that the adapter 100 has a bulge once the adapter 100 is disconnected with battery modules 200.

Then, the battery connector 130 of the adapter 100 is connected the first connector 210 of the nearest one of the battery modules 200, in this example, the first connector 210 here is a male connector.

Afterwards, the first connector 210 of the battery modules 200 which is the second nearest one to the adapter 100 is adapted to the second connector 210 of the detachable battery 200 which is the nearest one to the adapter 100 and so on, so as to form a layer-by-layer stacked battery modules structure.

The adapter 100 and the male connectors and the female connectors of the battery modules 200 will be a chimeric fixed structure, as shown in FIG. 2B. FIG. 2B is the schematic diagram of the combination of the battery connector 130 of the adapter 100 with the first connector 210 and the second connector 220 of multiple battery modules 200.

However, according to another embodiment, there may have the problem of the heat dissipation once the battery modules 200 are stacked layer-by-layer. The stacked power supply system in the present disclosure, wherein the battery connector 130 and the first connector 210 and the second connector 220 of the battery modules 200 can be connected via an additional connection cable. The connection cable is a detachable component. After connecting the first connector 210 and the second connector 220 with the connection cable, the structure will be fixed and there will have enough space for heat dissipation, so that the thermal energy due to the power transmission can be escaped.

Additionally, the stacked power supply system in the present disclosure, wherein the battery modules 200 can further be an independent power bank, and supply power to different electronic devices (e.g. cellphones, tablets, cameras, and so on) via the external connection cable.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A stacked power supply system applied for an electronic device, comprising:
an adapter, having a power plug, a power supply connector and a battery connector, wherein the adapter is adapted to be connected to an external AC power via the power plug, so as to convert an alternative current to a direct current, and the adapter supplies power to the electronic device via the power plug; and
a plurality of battery modules, wherein each one of the battery modules has a battery set, a first connector and a second connector, the first connector of one of the battery modules is electrically connected to the battery connector of the adapter, and the second connector of the other neighboring battery modules is adapted to be connected to the first connector of the neighboring battery modules, so as to form a stacked structure of the battery modules.

2. The stacked power supply system of claim 1, wherein the battery connector of the adapter is a male connector or a female connector.

3. The stacked power supply system of claim 1, wherein the battery set has one or more batteries and wherein the batteries are connected in parallel when there is more than one battery in the battery set.

4. The stacked power supply system of claim 2, wherein when the battery connector of the adapter is the male connector, the first connector of the battery modules is corresponded to a female connector, and the second connector of the battery modules is corresponded to a male connector.

5. The stacked power supply system of claim 2, wherein when the battery connector of the adapter is a female connector, the first connector of the battery modules is corresponded to a male connector, and the second connector of the battery modules is corresponded to a female connector.

6. The stacked power supply system of claim 1, wherein the battery modules have a case, wherein the case has a first side and a second side, the first side is parallel to the second side, the first side is the side facing to the battery connector of the adapter, the second side is the opposite side being away from the battery connector of the adapter, and the first connector is disposed on the first side, the second connector is disposed on the second side.

7. The stacked power supply system of claim 1, wherein the adapter has a contact surface, and wherein the battery connector is disposed on the contact surface.

8. The stacked power supply system of claim 6, wherein the adapter and the first side and the second side of the battery modules are closely fitted to the first connector and the second connector of the battery modules via the battery connector of the adapter, so as to form the stacked structure of the battery modules.

9. The stacked power supply system of claim 6, wherein the case further comprises a battery level indicator or an audio alarm.
